(19) United States
(12) Patent Application Publication
(10) Pub. No.: US 2026/0307195 A1
(43) Pub. Date: Oct. 8, 2026

(54) MACHINE TOOL CONTROL DEVICE

(71) Applicant: FANUC CORPORATION, Minamitsuru-gun, Yamanashi (JP)

(72) Inventor: Yuuki KUMAMOTO, Minamitsuru-gun, Yamanashi (JP)

(73) Assignee: FANUC CORPORATION, Minamitsuru-gun, Yamanashi (JP)

(21) Appl. No.: 19/483,138

(22) PCT Filed: May 30, 2023
(86) PCT No.: PCT/JP2023/020168

§ 371 Date: Nov. 10, 2025

(51) Int. Cl. B23Q 15/12; G05B 19/416

(52) U.S. Cl. CPC B23Q 15/12; G05B 19/416

(57) ABSTRACT

Provided is a machine tool control device with which it is possible to suppress acceleration/deceleration energy during a swing process in accordance with a purpose or application. A machine tool control device 1 comprises: a swing-condition-setting unit 11 that sets a swing condition; a swing condition calculation unit 12 that calculates a swing condition different from the aforementioned swing condition in order to reduce acceleration/deceleration energy required for a swing operation determined according to the aforementioned swing condition; a swing condition selection unit 13 that selects any one of the swing conditions set by each of the swing-condition-setting unit 11 and the swing condition calculation unit 12; a swing command calculation unit 14 that calculates a swing command on the basis of the swing condition selected by the swing condition selection unit 13; and a control unit (position control unit 18, speed/current control unit 19) that, on the basis of a movement command on which the swing command is superposed, causes a workpiece and a tool to swing relative to one another.

### TECHNICAL FIELD

The present disclosure relates to a control device for a machine tool.

### BACKGROUND ART

In conventionally known techniques pertaining to a control device for controlling a machine tool that performs oscillation machining in which a workpiece and a tool oscillate relative to each other, oscillation conditions such as information indicating an oscillation frequency are adjusted according to the purpose (e.g., Patent Document 1).

Patent Document 1 describes a technique for adjusting information indicating the frequency of an oscillation command such that the frequency of the oscillation command does not exceed an upper limit value, in order to prevent the cutting speed from becoming excessively high.

### CITATION LIST

### Patent Document

Patent Document 1: Japanese Unexamined Patent Application, Publication No. 2021-003802

### DISCLOSURE OF THE INVENTION

### Problems to be Solved by the Invention

In the meantime, when an approach of convolving an oscillation command with a movement command is used as a means for implementing oscillation cutting machining, an oscillation operation is convolved with an acceleration/deceleration, which is not included in a machining command when oscillation machining is not performed. Thus, the acceleration/deceleration energy required during the machining increases in comparison to when oscillation machining is not performed. Depending on what is machined or the purpose of the machining, there may be a case where it is desirable to minimize the increased or decreased acceleration/deceleration energy as much as possible.

The present disclosure is provided in view of the problem noted above, and an object thereof is to provide a technique for allowing a control device for a machine tool to save the acceleration/deceleration energy during oscillation machining in accordance with the purpose or application purpose.

### Means for Solving the Problems

The present disclosure is a control device for a machine tool that performs oscillation machining in which a workpiece and a tool are caused to oscillate relative to each other, the control device including: an oscillation condition setting unit that sets an oscillation condition; an oscillation condition calculation unit that calculates a different oscillation condition differing from the oscillation condition such that less acceleration/deceleration energy is required for an oscillation operation determined by the oscillation condition; an oscillation condition selection unit that selects either of the respective oscillation conditions set by the oscillation condition setting unit and the oscillation condition calculation unit; an oscillation command calculation unit that calculates an oscillation command on the basis of the oscillation condition selected by the oscillation condition selection unit; and a control unit that causes the workpiece and the tool to oscillate relative to each other on the basis of a movement command convolved with the oscillation command.

### Effects of the Invention

The present disclosure can provide a technique for allowing a control device for a machine tool to save the acceleration/deceleration energy during oscillation machining in accordance with the purpose or application purpose.

### BRIEF DESCRIPTION OF THE DRAWINGS

FIG. 1 is a functional block diagram of a control device for a machine tool according to a first embodiment;

FIG. 2 is a graph indicating a relationship achieved between speed and time when constant feed is performed;

FIG. 3 is a graph indicating a relationship achieved between speed and time when an oscillation command is convolved;

FIG. 4 is a graph indicating a relationship achieved between speed and time when an oscillation condition is changed;

FIG. 5 is a functional block diagram of a control device for a machine tool according to a second embodiment;

FIG. 6 is a functional block diagram of a control device for a machine tool according to a third embodiment;

FIG. 7 is a functional block diagram of a control device for a machine tool according to a fourth embodiment;

FIG. 8 is a functional block diagram of a control device for a machine tool according to a fifth embodiment;

FIG. 9 is a functional block diagram of a control device for a machine tool according to a sixth embodiment;

FIG. 10 is a functional block diagram of a control device for a machine tool according to a seventh embodiment;

FIG. 11 is a functional block diagram of a control device for a machine tool according to an eighth embodiment; and

FIG. 12 is a functional block diagram of a control device for a machine tool according to a ninth embodiment.

### PREFERRED MODE FOR CARRYING OUT THE INVENTION

The following describes embodiments of the present disclosure in detail by referring to the drawings. In the descriptions of the second embodiment and the following embodiments, like components are given like reference marks to those in the first embodiment, and descriptions thereof are omitted as appropriate herein.

### FIRST EMBODIMENT

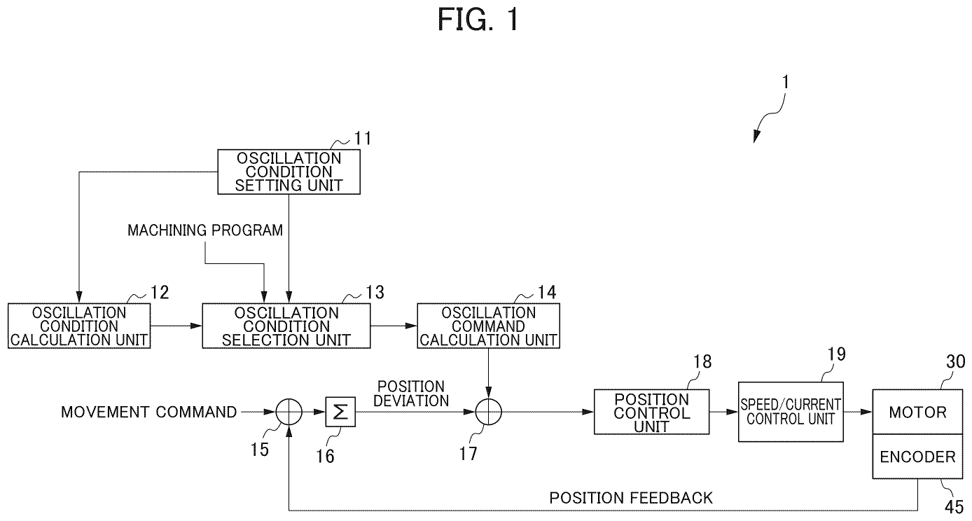

FIG. 1 is a functional block diagram of a control device 1 for a machine tool according to a first embodiment. The control device 1 for the machine tool is a computer for controlling the machine tool, the computer convolving an oscillation command for giving an instruction to cause relative oscillation between a workpiece and a cutting tool with a movement command for giving an instruction to achieve relative movement between the workpiece and the cutting tool, thereby causing an air cut to occur in cutting the workpiece such that chips are cut into smaller pieces. For example, the control device 1 for the machine tool is formed from a numerical control device.

The control device 1 for the machine tool according to the present embodiment includes an oscillation condition setting unit 11, an oscillation condition calculation unit 12, an oscillation condition selection unit 13, an oscillation command calculation unit 14, a first adder 15, a totalizer 16, a second adder 17, a position control unit 18, and a speed/current control unit 19.

The oscillation condition setting unit 11 sets oscillation conditions. Oscillation conditions are set by a user. Oscillation conditions may be designated by a machining program or may be set as a parameter for the control device 1 for the machine tool. For example, the oscillation condition setting unit 11 sets, as oscillation conditions, amplitude information that indicates an oscillation amplitude or an oscillation amplitude multiplying factor and frequency information that indicates an oscillation frequency or an oscillation frequency multiplying factor. The oscillation conditions formed from the oscillation amplitude or the oscillation amplitude multiplying factor and the oscillation frequency or the oscillation frequency multiplying factor are input to the oscillation condition selection unit 13.

The oscillation conditions include, as information for uniquely identifying an oscillatory waveform, at least a frequency parameter, which is information pertaining to the oscillation frequency of the cutting tool or the workpiece, and an amplitude parameter, which is information pertaining to the oscillation amplitude of the cutting tool or the workpiece. The frequency parameter may be the number of relative vibrations between the cutting tool and the workpiece per rotation or per unit time. Alternatively, the frequency parameter may be the cycle parameter of a forward/rearward movement operation. The amplitude parameter may be information pertaining to an oscillation amplitude specific to the amount of relative feed between the cutting tool and the workpiece per rotation, or the distance parameter of the forward/rearward movement operation. The cycle parameter of the forward/rearward movement operation and the distance parameter of the forward/rearward movement operation may be decided on according to, for example, a forward movement speed, a rearward movement speed, a forward movement distance, a rearward movement distance, a spindle rotation number, and a control cycle. The frequency parameter and the amplitude parameter may be decided on according to, for example: the spindle rotation number; a per-rotation feed speed; a per-minute feed speed; a frequency multiplying factor, which is the number of relative vibrations between the cutting tool and the workpiece per rotation; and an amplitude multiplying factor, which is an oscillation amplitude specific to the amount of relative feed between the cutting tool and the workpiece per rotation.

The oscillation condition calculation unit 12 calculates different oscillation conditions (amplitude information and frequency information) from the oscillation condition setting unit 11 such that less acceleration/deceleration energy is required for the oscillation operation.

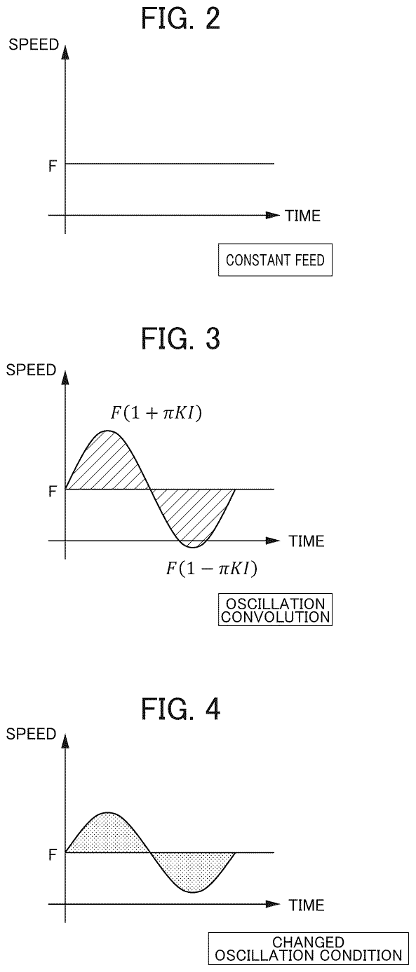

The following describes a method used by the oscillation condition calculation unit 12 to calculate oscillation conditions. FIG. 2 is a graph indicating a relationship achieved between speed and time when constant feed is performed. FIG. 3 is a graph indicating a relationship achieved between speed and time when an oscillation command is convolved.

As indicated in FIGS. 2 and 3, the speed after oscillation command convolution can be represented using the numerical equation (1) below. In numerical equation (1), v indicates the speed after oscillation command convolution; F, a constant feed speed; K, an oscillation amplitude multiplying factor (an example of the amplitude information); I, an oscillation frequency multiplying factor (an example of the frequency information); S, a spindle rotation number; and t, time. The acceleration/deceleration energy required for the oscillation operation can be determined by multiplying the second term on the right side of numerical equation (1) by the mass m of an object on which the oscillation operation is to be performed and then integrating the result with respect to time t. Note that the mass m is not always necessary when discussing energy. For example, as long as the mass m is constant, the energy increase/decrease can also be identified by integrating speed with respect to time t.

$$\begin{matrix}Formula 1 & \\ v = F + π RFI sin ( 2 π \frac{IS}{60} t ) & NUMERICAL EQUATION ( 1 )\end{matrix}$$

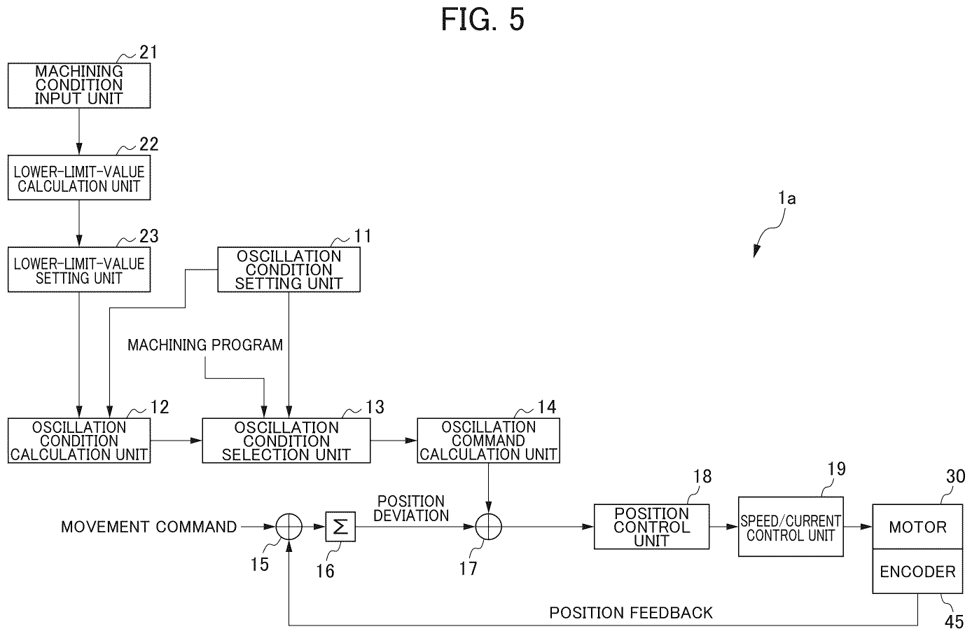

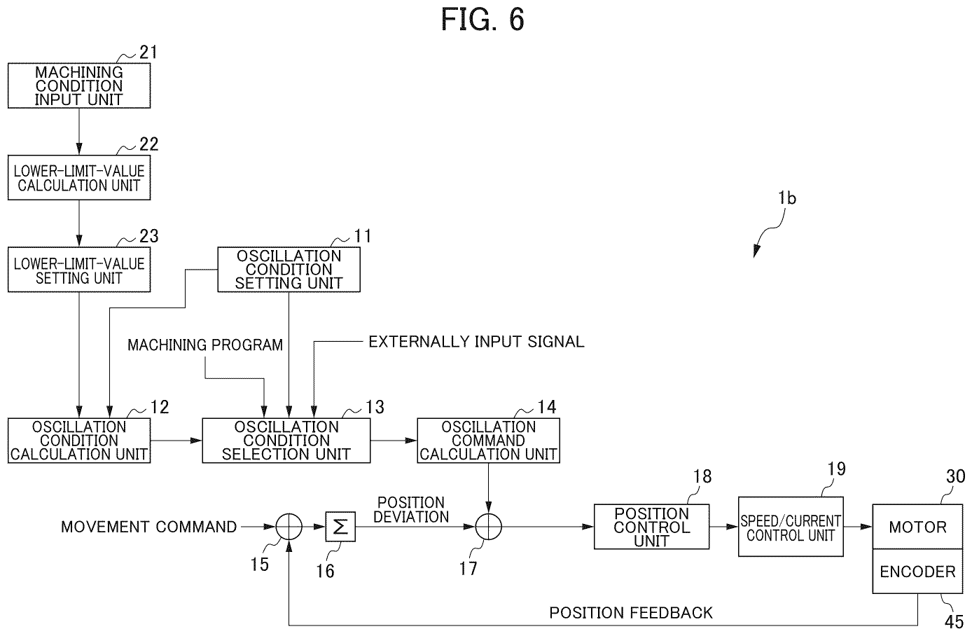

FIG. 4 is a graph indicating a relationship achieved between speed and time when the oscillation condition is changed. As can be understood from numerical equation (1), the oscillation amplitude multiplying factor K or the oscillation frequency multiplying factor I may be lowered such that less acceleration/deceleration energy is required for the oscillation operation. The oscillation condition calculation unit 12 calculates oscillation conditions such that the oscillation amplitude multiplying factor K and/or the oscillation frequency multiplying factor I are/is lowered.

The oscillation amplitude multiplying factor K and the oscillation frequency multiplying factor I have a relationship of tradeoff with chip shredding. Lowering the oscillation amplitude multiplying factor K reduces an amplitude margin required for causing an air cut, thereby making the air cut unlikely to occur. Lowering the oscillation frequency multiplying factor I shifts a phase for causing an air cut, thereby making the air cut unlikely to occur. The oscillation condition calculation unit 12 calculates, as oscillation conditions, amplitude information and frequency information on the basis of a numerical equation and coefficient in which user intentions pertaining to an air cut are reflected. The oscillation conditions calculated by the oscillation condition calculation unit 12 are input to the oscillation condition selection unit 13.

The oscillation condition selection unit 13 selects an oscillation condition on the basis of a selection condition set by the user. In the first embodiment, the oscillation condition selection unit 13 selects, on the basis of a selection condition designated by the machining program, an oscillation condition set by the oscillation condition setting unit 11 or an oscillation condition calculated by the oscillation condition calculation unit 12. For example, the machining program has designated therein a code corresponding to “oscillation condition 1,” which indicates that the oscillation condition based on the oscillation condition setting unit 11 should be used, a code corresponding to “oscillation condition 2,” which indicates that the oscillation condition based on the oscillation condition calculation unit 12 should be used, and the like.

The oscillation command calculation unit 14 calculates an oscillation command on the basis of the oscillation condition selected by the oscillation condition selection unit 13. The oscillation command calculated by the oscillation command calculation unit 14 is input to the second adder 17.

The first adder 15 calculates a position deviation. The first adder 15 calculates a position deviation that is the difference between a movement command and position feedback based on position detection performed for a motor 30 of a feed axis by an encoder 45. The position deviation calculated by the first adder 15 is input to the totalizer 16.

The totalizer 16 calculates a total position deviation value. Specifically, the totalizer 16 calculates a total position deviation value by totalizing position deviations calculated by the first adder 15. The total value calculated by the totalizer 16 is input to the second adder 17.

The second adder 17 generates a convolution command. Specifically, the second adder 17 generates a convolution command by adding an oscillation command generated by the oscillation command calculation unit 14 to a total position deviation value calculated by the totalizer 16 (by convolving the oscillation command and the total position deviation value). The convolution command generated by the second adder 17 is input to the position control unit 18. Note that the processing pertaining to the position deviation may be omitted, and the second adder 17 may add the oscillation command generated by the oscillation command calculation unit 14 to a movement command (position command).

The position control unit 18 generates a position command on the basis of the convolution command, and outputs the same to the speed/current control unit 19. The speed/current control unit 19 outputs, to the motor 30, an operation command for controlling the speed and the current on the basis of the position command. As a result, the machine tool performs oscillation machining in which the workpiece and the tool oscillate relative to each other.

As described above, the control device 1 for the machine tool according to the first embodiment includes: an oscillation condition setting unit 11 that sets an oscillation condition; an oscillation condition calculation unit 12 that calculates a different oscillation condition differing from the oscillation condition such that less acceleration/deceleration energy is required for an oscillation operation determined by the oscillation condition; an oscillation condition selection unit 13 that selects either of the respective oscillation conditions set by the oscillation condition setting unit 11 and the oscillation condition calculation unit 12; an oscillation command calculation unit 14 that calculates an oscillation command on the basis of the oscillation condition selected by the oscillation condition selection unit 13; and a control unit (position control unit 18, speed/current control unit 19) that causes the workpiece and the tool to oscillate relative to each other on the basis of a movement command convolved with the oscillation command.

As a result, the oscillation condition selection unit 13 can make a selection to ease the oscillation conditions so that acceleration/deceleration energy increased by performing oscillation machining can be reduced. Presetting a selection condition for the oscillation condition selection unit 13 allows oscillation machining to be performed with appropriate acceleration/deceleration energy according to the purpose of the user.

The oscillation condition setting unit 11 sets, as the oscillation conditions, amplitude information (e.g., oscillation amplitude, oscillation amplitude multiplying factor) that indicates an oscillation amplitude and frequency information (e.g., oscillation frequency, oscillation frequency multiplying factor) indicating an oscillation frequency, and the oscillation condition calculation unit 12 calculates, as the oscillation conditions, setting values obtained by varying the amplitude information and the frequency information. As a result, the oscillation conditions can be eased by changing the numerical values of the amplitude information indicating an oscillation amplitude and the frequency information indicating an oscillation frequency.

On the basis of the designation in the machining program, the oscillation condition selection unit 13 selects either of the respective oscillation conditions set by the oscillation condition setting unit 11 and the oscillation condition calculation unit 12. Thus, in accordance with the designation by the machining program, settings can be easily made as to whether to ease the oscillation conditions.

### SECOND EMBODIMENT

FIG. 5 is a functional block diagram of a control device 1a for a machine tool according to a second embodiment. In addition to the components in the first embodiment, the control device 1a for the machine tool according to the second embodiment includes a machining condition input unit 21, a lower-limit-value calculation unit 22, and a lower-limit-value setting unit 23.

The machining condition input unit 21 inputs a machining condition to the lower-limit-value calculation unit 22. Machining conditions in the present embodiment are parameters that are set in addition to oscillation conditions and that are required for machining, and include, for example, a spindle rotation number and a feed-axis speed. For example, a machining condition may be designated by the machining program or may be set as a parameter for the control device 1a for the machine tool.

The lower-limit-value calculation unit 22 calculates a lower limit value for at least either amplitude information or frequency information on the basis of the input machining condition. For example, the lower-limit-value calculation unit 22 calculates, for the amplitude information and the frequency information, a condition required for causing an air cut with respect to the machining condition.

The lower-limit-value setting unit 23 calculates, as the lower limit value, the condition calculated by the lower-limit-value calculation unit 22. The lower limit value set by the lower-limit-value setting unit 23 is input to the oscillation condition calculation unit 12.

The oscillation condition calculation unit 12 in the second embodiment calculates amplitude information and frequency information on the basis of a preset setting condition and the lower limit value set by the lower-limit-value setting unit 23. The setting condition in the second embodiment is the product of the amplitude information and frequency information calculated being lower than the product of the amplitude information and frequency information set by the oscillation condition setting unit 11.

In the second embodiment, the oscillation condition calculation unit 12 calculates amplitude information and frequency information such that the two are higher than the lower limit value for the amplitude information and the lower limit value for the frequency information with the setting condition being satisfied. The calculated amplitude information and frequency information are input to the oscillation condition selection unit 13. The remaining processing operations are similar to those in the first embodiment.

As described above, the control device 1a for the machine tool according to the second embodiment further includes a lower-limit-value setting unit 23 that sets a lower limit value for the setting value of at least one of amplitude information or frequency information, and the product of the amplitude information and frequency information calculated by the oscillation condition calculation unit 12 is lower than the product of the amplitude information and frequency information set by the oscillation condition setting unit 11, and is higher than the lower limit value.

In the meantime, with respect to allowing the oscillation operation to be performed with less acceleration/deceleration energy, the energy could be saved most effectively, speaking in the extreme, by skipping the oscillation operation, but this would lead to the loss of the chip shredding performance. In this regard, the features of the present embodiment involve setting a lower limit value and thus can prevent the chip shredding performance from being lost.

The acceleration/deceleration energy is proportional to the square of the product of the oscillation frequency and the oscillation amplitude. The features of the present embodiment can reliably save the acceleration/deceleration energy since the product of the oscillation frequency and oscillation amplitude calculated by the lower-limit-value calculation unit 22 is lower than the product of the oscillation frequency and oscillation amplitude provided as setting values.

The control device 1a for the machine tool according to the second embodiment further includes a machining condition input unit 21 that inputs machining conditions, and a lower-limit-value calculation unit 22 that calculates, for amplitude information and frequency information on the basis of the machining conditions, a condition required for causing an air cut. The lower-limit-value setting unit 23 sets, as a lower limit value, the condition calculated for the amplitude information and the frequency information by the lower-limit-value calculation unit 22. Accordingly, amplitude information and frequency information required for causing an air cut can be derived from machining conditions such as the spindle rotation number and the feed-axis speed without additionally setting a lower limit value.

In the second embodiment, the control device 1a for the machine tool further includes the machining condition input unit 21, the lower-limit-value calculation unit 22, and the lower-limit-value setting unit 23. However, the present invention is not limited to this configuration. For example, the machining condition input unit 21 and the lower-limit-value calculation unit 22 may be omitted from the control device 1a for the machine tool. For example, a numerical value theoretically or empirically set as a lower limit value for at least one of amplitude information or frequency information may be preset for the lower-limit-value setting unit 23, and the oscillation condition calculation unit 12 may calculate amplitude information and frequency information on the basis of the lower limit value.

### THIRD EMBODIMENT

FIG. 6 is a functional block diagram of a control device 1b for a machine tool according to a third embodiment. The control device 1b for the machine tool according to the third embodiment involves the feature of the oscillation condition selection unit 13 of receiving an input of an external signal, in addition to the features of the second embodiment.

The external signal includes information for selecting an oscillation condition. For example, the external signal is provided by an operation means (not shown) or an external computer and designates an energy-saving mode in which the acceleration/deceleration energy is reduced. In a case where the external signal designates the energy-saving mode, the oscillation condition selection unit 13 selects an oscillation condition calculated by the oscillation condition calculation unit 12.

As described above, the oscillation condition selection unit 13 of the control device 1b for the machine tool according to the third embodiment selects, on the basis of a signal input from the outside, either of the respective oscillation conditions set by the oscillation condition setting unit 11 and the oscillation condition calculation unit 12. Thus, by using the external signal, it can be determined whether to ease the oscillation condition according to the circumstances.

### FOURTH EMBODIMENT

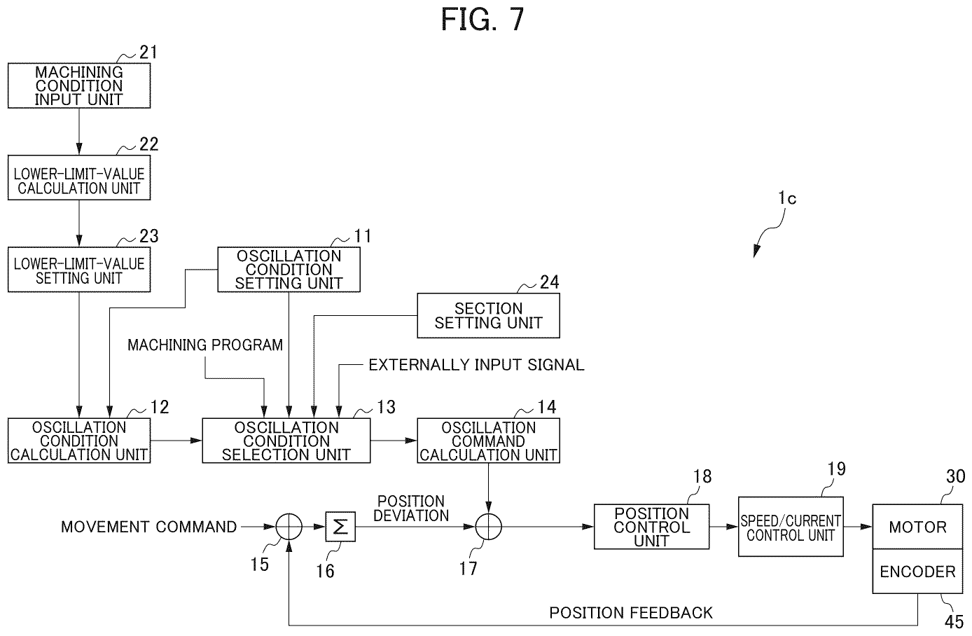

FIG. 7 is a functional block diagram of a control device 1c for a machine tool according to a fourth embodiment. In addition to the components in the second embodiment, the control device 1c for the machine tool according to the fourth embodiment includes a section setting unit 24.

The section setting unit 24 inputs a predesignated machining section and/or machining time to the oscillation condition selection unit 13. The information input from the section setting unit 24 to the oscillation condition selection unit 13 has designated therein oscillation conditions to be selected for a machining section and/or machining time to be designated.

For example, a setting is made for a certain machining section A such that an oscillation condition set by the oscillation condition setting unit 11 should be employed, and a setting is made for another machining section B such that an oscillation condition selected by the oscillation condition calculation unit 12 should be employed. Alternatively, a setting is made for a certain machining time C such that an oscillation condition calculated by the oscillation condition calculation unit 12 should be employed, and a setting is made for another machining time D such that an oscillation condition set by the oscillation condition setting unit 11 should be employed.

Furthermore, the section setting unit 24 can combine a machining section and a machining time so as to designate an oscillation condition to be employed. For example, oscillation machining can be performed such that, only when the machining section B and the machining time C have been designated, the oscillation condition calculated by the oscillation condition calculation unit 12 is employed.

As described above, the oscillation condition selection unit 13 of the control device 1c for the machine tool according to the fourth embodiment selects, on the basis of at least one of a predesignated machining section or machining time, either of the respective oscillation conditions set by the oscillation condition setting unit 11 and the oscillation condition calculation unit 12. As a result, the acceleration/deceleration energy can be reduced by easing the oscillation condition in accordance with the desired machining section or machining time. Oscillation machining is achieved under an oscillation condition optimized according to the machining state.

### FIFTH EMBODIMENT

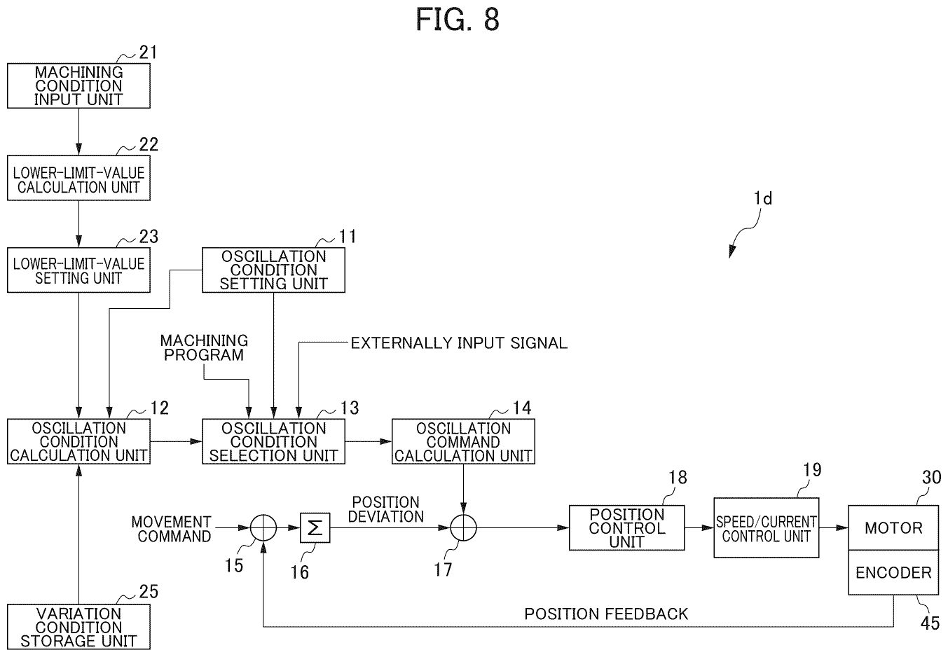

FIG. 8 is a functional block diagram of a control device 1d for a machine tool according to a fifth embodiment. In addition to the components in the second embodiment, the control device 1d for the machine tool according to the fifth embodiment includes a variation condition storage unit 25.

The variation condition storage unit 25 stores variation conditions for the oscillation condition calculation unit 12 to calculate amplitude information and frequency information. A plurality of variation conditions are stored, e.g., “high-level energy saving” for achieving a relatively large decrease amount by which the acceleration/deceleration energy is decreased, “low-level energy saving” for achieving a relatively small decrease amount by which the acceleration/deceleration energy is decreased, “normal” for achieving a moderate decrease amount by which the acceleration/deceleration energy is decreased. Numerical equations and coefficients are set for the plurality of variation conditions in accordance with the purpose.

The oscillation condition calculation unit 12 brings up a variation condition stored by the variation condition storage unit 25, and calculates amplitude information and frequency information meeting the variation condition. The amplitude information and frequency information calculated by the oscillation condition calculation unit 12 are input to the oscillation condition selection unit 13.

The oscillation condition selection unit 13 outputs, to the oscillation command calculation unit 14, amplitude information and frequency information corresponding to a variation condition selected on the basis of the designation by, for example, the machining program. The remaining processing operations are similar to those in the embodiments described above.

As described above, the control device 1d for the machine tool according to the fifth embodiment further includes a variation condition storage unit 25 that stores a plurality of variation conditions for the oscillation condition calculation unit 12 to vary amplitude information and frequency information, and the oscillation condition calculation unit 12 can calculate an oscillation condition for each of the plurality of variation conditions stored by the variation condition storage unit 25. As a result, the amount by which the acceleration/deceleration energy is reduced can be adjusted according to the purpose, and the user convenience can be improved.

In the fifth embodiment, the oscillation condition calculation unit 12 calculates amplitude information and frequency information on the basis of individual variation conditions. However, the present invention is not limited to this configuration. The oscillation condition calculation unit 12 may initially receive a result of selection by the oscillation condition selection unit 13, and calculate amplitude information and frequency information on the basis of a variation condition corresponding to the result of selection.

### SIXTH EMBODIMENT

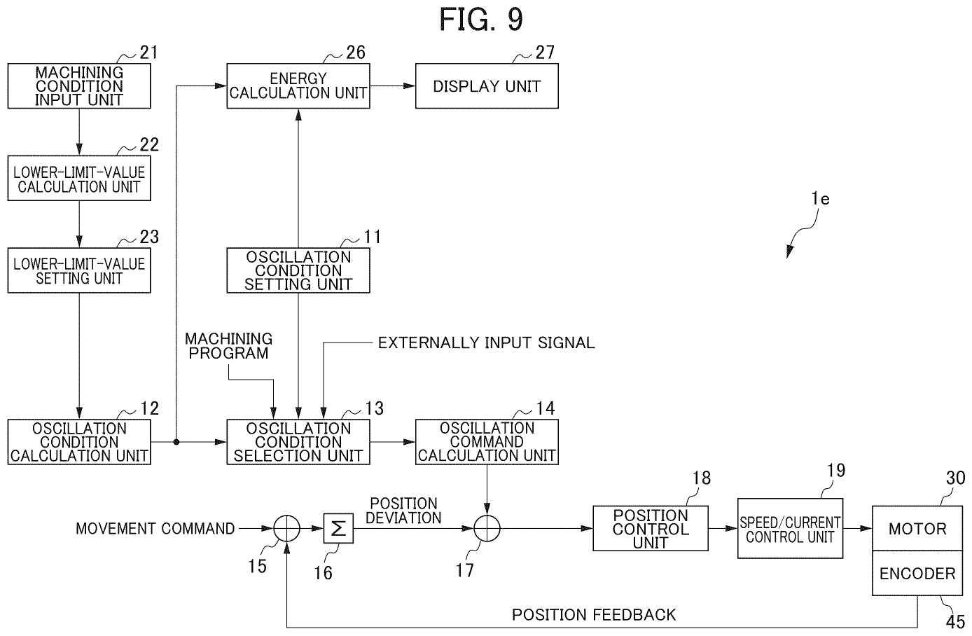

FIG. 9 is a functional block diagram of a control device 1e for a machine tool according to a sixth embodiment. In addition to the components in the third embodiment, the control device 1e for the machine tool according to the sixth embodiment includes an energy calculation unit 26 and a display unit 27.

The energy calculation unit 26 calculates acceleration/deceleration energy required for an oscillation operation on the basis of input oscillation conditions. In the sixth embodiment, the energy calculation unit 26 receives information indicating an oscillation condition from each of the oscillation condition setting unit 11 and the oscillation condition calculation unit 12. The energy calculation unit 26 calculates acceleration/deceleration energy corresponding to each of the received oscillation conditions.

The energy calculation unit 26 may calculate acceleration/deceleration energy in joules (J), which typically indicates energy, by means of the integration noted above, or may calculate acceleration/deceleration energy by using another calculation method. For example, the acceleration/deceleration energy may be output in the form of an amount of CO₂ emissions obtained through conversion performed on the basis of a prescribed conversion formula. The acceleration/deceleration energy calculated by the energy calculation unit 26 is input to the display unit 27.

The display unit 27 displays the acceleration/deceleration energy input from the energy calculation unit 26 on the display of the control device 1e for the machine tool or on an external computer. As noted above, the display unit 27 conveys the magnitude of the acceleration/deceleration energy to the user in joules (J) or in the form of an amount of CO₂ emissions. In the sixth embodiment, the display unit 27 performs the process of displaying acceleration/deceleration energy corresponding to each of the oscillation conditions from the oscillation condition setting unit 11 and the oscillation condition calculation unit 12. Note that the display unit 27 may not only perform the displaying processing, but also may constitute a display.

As described above, the control device 1e for the machine tool according to the sixth embodiment further includes: an energy calculation unit 26 that calculates acceleration/deceleration energy required for an oscillation operation on the basis of oscillation conditions; and a display unit 27 that calculates at least either energy based on an oscillation condition set by the oscillation condition setting unit 11 or energy associated with an oscillation condition calculated by the oscillation condition calculation unit 12 and displays acceleration/deceleration energy corresponding to the oscillation condition. Thus, the user can grasp the acceleration/deceleration energy meeting the oscillation condition. In the sixth embodiment, corresponding acceleration/deceleration energy is displayed for each of the oscillation condition setting unit 11 and the oscillation condition calculation unit 12, so that the user can identify, through comparison, the difference between a situation in which the adjustment is not made and a situation in which the adjustment is made.

### SEVENTH EMBODIMENT

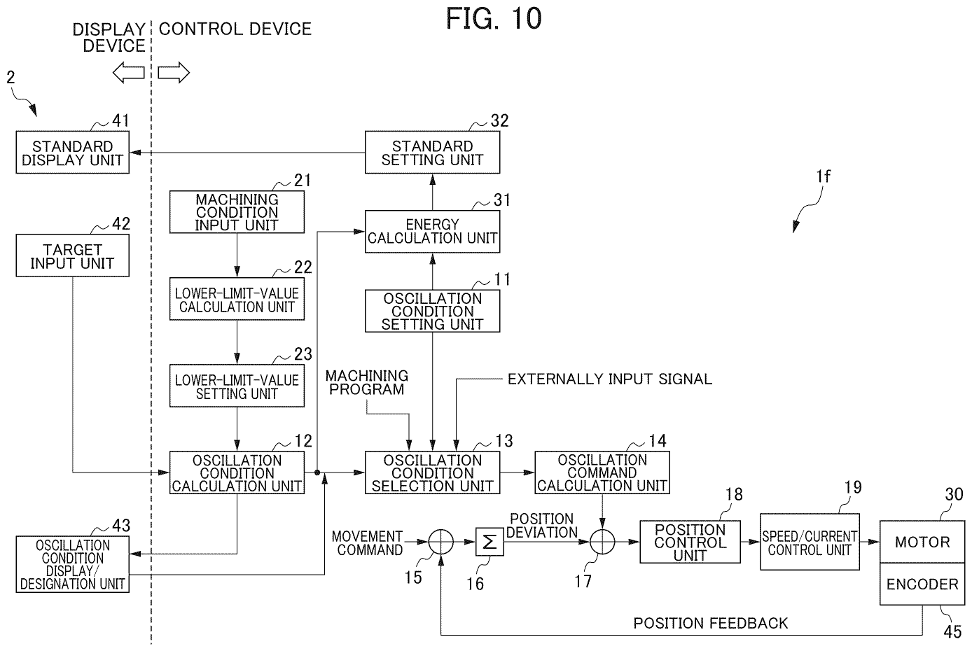

FIG. 10 is a functional block diagram of a control device 1f for a machine tool according to a seventh embodiment. The control device 1f for the machine tool according to the seventh embodiment includes a display device 2 for implementing a graphical user interface (GUI) function. For example, the display device 2 is formed from a display means such as a display for displaying various types of information, and operation means such as a touch panel, a keyboard, and a button.

The following describes the function of the control device 1f for the machine tool and the function of the display device 2. In addition to the components in the third embodiment, the control device 1f for the machine tool includes an energy calculation unit 31 and a standard setting unit 32. The display device 2 includes a standard display unit 41, a target input unit 42, and an oscillation condition display/designation unit 43.

The energy calculation unit 31 calculates acceleration/deceleration energy required for an oscillation operation on the basis of an input oscillation condition. The energy calculation unit 31 in the seventh embodiment calculates acceleration/deceleration energy corresponding to the oscillation condition received from the oscillation condition setting unit 11. The energy calculation unit 31 may calculate acceleration/deceleration energy in joules (J), which typically indicates energy, by means of the integration noted above, or may calculate acceleration/deceleration energy by using another calculation method. For example, the acceleration/deceleration energy may be output in the form of an amount of CO₂ emissions obtained through conversion performed on the basis of a prescribed conversion formula.

Information indicating the acceleration/deceleration energy calculated by the energy calculation unit 31 in the seventh embodiment is input to the standard setting unit 32. The standard setting unit 32 outputs the information indicating the acceleration/deceleration energy calculated by the energy calculation unit 31 to the standard display unit 41 of the display device 2.

The standard display unit 41 on the display device 2 side displays, as information indicating a standard, acceleration/deceleration energy calculated on the basis of an oscillation condition set by the oscillation condition setting unit 11.

Next, descriptions are given of the target input unit 42. The target input unit 42 receives a condition for calculating acceleration/deceleration energy designated by the user, and outputs received information to the oscillation condition calculation unit 12. The information received by the target input unit 42 is target acceleration/deceleration energy determined with reference to a prescribed standard, or the proportion of decrease in acceleration/deceleration energy with reference to the prescribed standard. A prescribed standard in the seventh embodiment is an oscillation condition set by the machining program (oscillation condition setting unit 11).

The oscillation condition calculation unit 12 in the seventh embodiment calculates oscillation condition(s) satisfying the condition designated by the target input unit 42. One or more oscillation conditions may be calculated as long as the same satisfy the designated condition. The result of calculation by the oscillation condition calculation unit 12 is output to the oscillation condition display/designation unit 43. The oscillation condition display/designation unit 43 may present a plurality of patterns of combinations of amplitude information and frequency information.

The oscillation condition display/designation unit 43 displays the result of calculation by the oscillation condition calculation unit 12. The oscillation condition display/designation unit 43 also receives an operation performed by the user, who has checked the displayed result of calculation by the oscillation condition calculation unit 12, and determines the result of selection by the user. Then, the oscillation condition display/designation unit 43 outputs the result of selection by the user to the oscillation condition selection unit 13. As a result, the oscillation condition calculated by the oscillation condition calculation unit 12 satisfies the condition designated by the user (e.g., amplitude information, prescribed combination of oscillation conditions, air cut margin settings).

The oscillation condition selection unit 13 selects one of the oscillation condition corresponding to the result of selection by the user or the oscillation condition set by the oscillation condition setting unit 11. As in the embodiments described above, a selection standard is set on the basis of, for example, the machining program or an external signal.

As described above, the control device 1f for the machine tool according to the seventh embodiment includes: an energy calculation unit 31 that calculates acceleration/deceleration energy required for an oscillation operation on the basis of an oscillation condition set by the oscillation condition setting unit 11; a standard display unit 41 that displays, as a standard, information based on the acceleration/deceleration energy calculated by the energy calculation unit 31; a target input unit 42 that inputs target acceleration/deceleration energy determined with reference to the standard, or the proportion of decrease in acceleration/deceleration energy with reference to the standard; and an oscillation condition display/designation unit 43 that displays one or more oscillation conditions calculated such that the oscillation condition calculation unit 12 satisfies the condition input by the target input unit 42, and that designates at least one of the displayed oscillation conditions. The oscillation condition selection unit 13 selects either the oscillation condition designated by the oscillation condition display/designation unit 43 or the oscillation condition set by the oscillation condition setting unit 11. As a result, the oscillation condition calculation unit 12 calculates an oscillation condition corresponding to the designation by the user, and when the result of calculation has been selected by the oscillation condition selection unit 13, oscillation machining can be performed with acceleration/deceleration energy meeting the user need at a higher level.

### EIGHTH EMBODIMENT

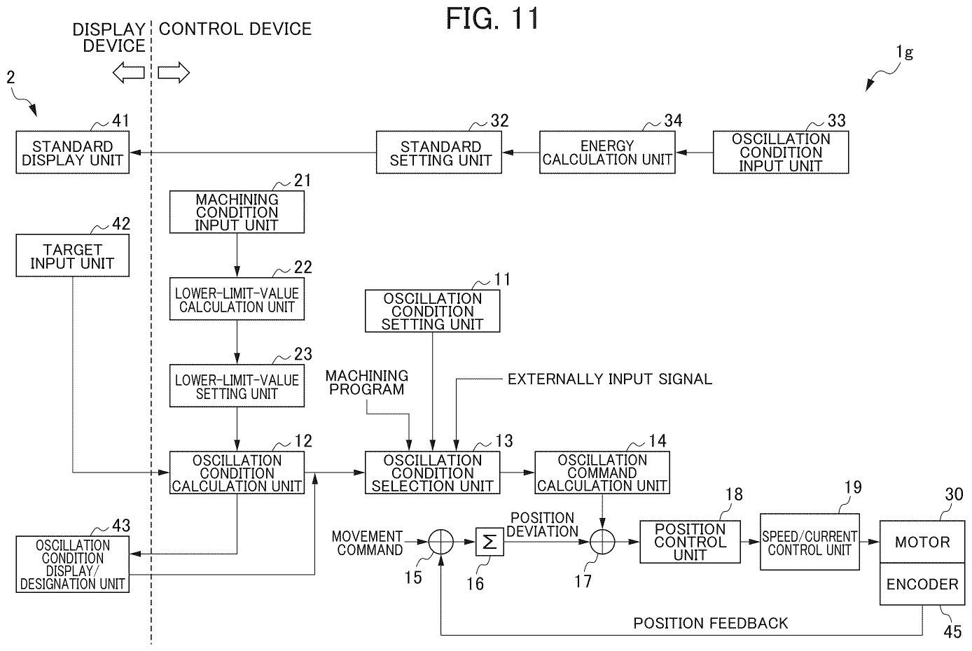

FIG. 11 is a functional block diagram of a control device 1g for a machine tool according to an eighth embodiment. In addition to the components in the seventh embodiment, the control device 1g for the machine tool includes an oscillation condition input unit 33. The energy calculation unit 34 in the eighth embodiment performs different processing from the energy calculation unit 31 in the seventh embodiment.

The oscillation condition input unit 33 outputs, to the energy calculation unit 34, a standard oscillation condition for indicating a standard to the user. The standard oscillation condition output by the oscillation condition input unit 33 may be acquired from a parameter set for the machine tool or the control device 1g for the machine tool, or the user may acquire the standard oscillation condition from, for example, an input means or an external computer.

The energy calculation unit 34 in the eighth embodiment calculates acceleration/deceleration energy required for an oscillation operation based on an oscillation condition input from the oscillation condition input unit 33. The energy calculation unit 34 may calculate acceleration/deceleration energy in joules (J), which typically indicates energy, by means of the integration noted above, or may calculate acceleration/deceleration energy by using another calculation method. For example, the acceleration/deceleration energy may be output in the form of an amount of CO₂ emissions obtained through conversion performed on the basis of a prescribed conversion formula. The acceleration/deceleration energy calculated by the energy calculation unit 34 is output to the standard setting unit 32.

The standard setting unit 32 outputs information indicating a standard to the standard display unit 41. The standard display unit 41 displays, as standard acceleration/deceleration energy, information based on an oscillation condition input by the oscillation condition input unit 33. The remaining processing operations are similar to those in the seventh embodiment.

As described above, the control device 1g for the machine tool according to the eighth embodiment includes: an oscillation condition input unit 33 that inputs an oscillation condition to serve as standard acceleration/deceleration energy associated with an oscillation operation; an energy calculation unit 34 that calculates acceleration/deceleration energy required for the oscillation operation on the basis of the oscillation condition input by the oscillation condition input unit 33; a target input unit 42 that inputs target acceleration/deceleration energy determined with reference to a standard constituted by information based on the acceleration/deceleration energy calculated by the energy calculation unit 34, or the proportion of decrease in acceleration/deceleration energy with reference to the standard; and an oscillation condition display/designation unit 43 that displays one or more oscillation conditions calculated such that the oscillation condition calculation unit 12 satisfies the condition input by the target input unit 42, and that designates at least one of the displayed oscillation conditions. The oscillation condition selection unit 13 selects either the oscillation condition designated by the oscillation condition display/designation unit 43 or the oscillation condition set by the oscillation condition setting unit 11.

In this configuration, the oscillation condition calculation unit 12 also calculates an oscillation condition corresponding to the designation by the user, and when the result of calculation has been selected by the oscillation condition selection unit 13, oscillation machining can be performed with acceleration/deceleration energy meeting the user need at a higher level. Furthermore, the user can designate acceleration/deceleration energy by referring to a standard that is designated by the user or a standard that is set on the basis of a parameter of the machine tool.

### NINTH EMBODIMENT

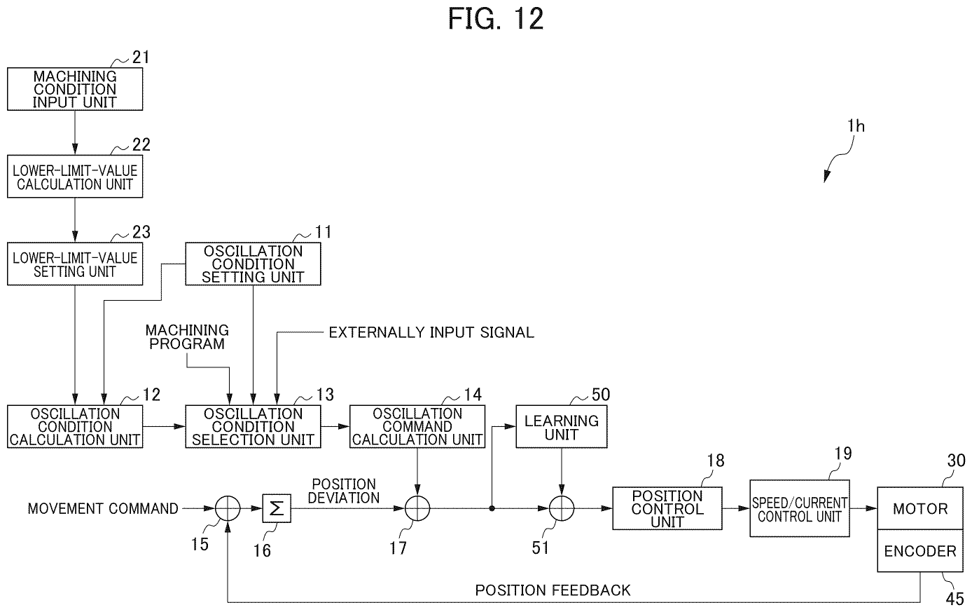

FIG. 12 is a functional block diagram of a control device 1h for a machine tool according to a ninth embodiment. In addition to the components in the third embodiment, the control device 1h for the machine tool according to the ninth embodiment includes a learning unit 50 and a third adder 51. The learning unit 50 and the third adder 51 are disposed between the second adder 17 and the position control unit 18.

The learning unit 50 calculates a correction amount on the basis of a convolution command generated for a total position deviation value and an oscillation command by the second adder 17. The learning unit 50, which has a memory, stores an oscillation phase and a correction amount in the memory such that the oscillation phase and the correction amount are associated with each other in one or more cycles of oscillation, reads the convolution command stored in the memory at a timing at which can be compensated for a phase delay that occurs in the oscillation operation and corresponds to the responsiveness of the motor 30, and then outputs the convolution command to the third adder 51 as a correction amount. In the meantime, if the oscillation phases stored in the memory do not include an oscillation phase for which a correction amount is to be output, a correction amount to be output may be calculated from correction amounts associated with oscillation phases close to the oscillation phase.

The third adder 51 adds the correction amount input from the learning unit 50 to a convolution command generated for a total position deviation value and an oscillation command by the second adder 17. The convolution command corrected by the learning unit 50 and the third adder 51 is output to the position control unit 18. The remaining processing operations are similar to those in the embodiments described above.

As described above, the control device 1h for the machine tool according to the ninth embodiment further includes: an encoder 45, which serves as a position detection unit for detecting position information pertaining to the motor 30, which serves as a driver for moving at least either a workpiece or a tool; a first adder 15, which serves as a position deviation calculation unit for calculating a position deviation from the position information detected by the encoder 45; and a learning unit 50 that calculates a correction amount for the position deviation on the basis of an oscillation command and a position deviation and corrects the position deviation by adding the calculated correction amount to the position deviation. As a general rule, the higher the oscillation frequency is, the larger the deviation pertaining to the convolution command is. In this regard, according to the features of the present embodiment, the ability to follow the cyclic convolution command can be improved owing to the correction made by the learning unit 50. According to the features of the present embodiment, in particular, when the result of calculation is selected by the oscillation condition selection unit 13, oscillation machining with acceleration/deceleration energy meeting the user intention can be performed more accurately.

When disposing the learning unit 50 in another embodiment such as the seventh or eighth embodiment, the learning unit 50 can be installed at a similar location to the ninth embodiment.

The present disclosure is not limited to the above-described implementations, and encompasses variations and improvements with which objects of the present disclosure can be achieved.

The following additional remarks are further disclosed with respect to the above-described embodiments and variations.

### Additional Remark 1

A control device (1, 1a to 1h) for a machine tool that performs oscillation machining in which a workpiece and a tool are caused to oscillate relative to each other, the control device including:
an oscillation condition setting unit (11) that sets an oscillation condition;
an oscillation condition calculation unit (12) that calculates a different oscillation condition differing from the oscillation condition such that less acceleration/deceleration energy is required for an oscillation operation determined by the oscillation condition;
an oscillation condition selection unit (13) that selects either of the respective oscillation conditions set by the oscillation condition setting unit (11) and the oscillation condition calculation unit (12);
an oscillation command calculation unit (14) that calculates an oscillation command on the basis of the oscillation condition selected by the oscillation condition selection unit (13); and
a control unit (18, 19) that causes the workpiece and the tool to oscillate relative to each other on the basis of a movement command convolved with the oscillation command.

### Additional Remark 2

The control device (1, 1a to 1h) for the machine tool, wherein the oscillation condition setting unit (11) sets, as the oscillation condition, amplitude information indicating an oscillation amplitude and frequency information indicating an oscillation frequency, and the oscillation condition calculation unit (12) calculates, as the oscillation condition, a setting value obtained by varying the amplitude information and the frequency information.

### Additional Remark 3

The control device (1a to 1h) for the machine tool, the control device further including a lower-limit-value setting unit (23) that sets a lower limit value for the setting value of at least one of the amplitude information or the frequency information, wherein the product of the amplitude information and the frequency information calculated by the oscillation condition calculation unit (12) is lower than the product of the amplitude information and the frequency information set by the oscillation condition setting unit (11), and is higher than the lower limit value.

### Additional Remark 4

The control device (1a to 1h) for the machine tool, the control device further including
a machining condition input unit (21) that inputs a machining condition; and
a lower-limit-value calculation unit (22) that calculates, for the amplitude information and the frequency information, a condition required for causing an air cut on the basis of the machining condition, wherein
the lower-limit-value setting unit (23) sets, as a lower limit value, the condition calculated for the amplitude information and the frequency information by the lower-limit-value calculation unit (22).

### Additional Remark 5

The control device (1, 1a to 1h) for the machine tool, wherein on the basis of the designation in a machining program, the oscillation condition selection unit (13) selects either of the respective oscillation conditions set by the oscillation condition setting unit (11) and the oscillation condition calculation unit (12).

### Additional Remark 6

The control device (1a to 1c, 1e) for the machine tool, wherein
the oscillation condition selection unit (13) selects, on the basis of a signal input from the outside, either of the respective oscillation conditions set by the oscillation condition setting unit (11) and the oscillation condition calculation unit (12).

### Additional Remark 7

The control device (1c) for the machine tool, wherein the oscillation condition selection unit (13) selects, on the basis of at least one of a predesignated machining section or machining time, either of the respective oscillation conditions set by the oscillation condition setting unit (11) and the oscillation condition calculation unit (12).

### Additional Remark 8

The control device (1d) for the machine tool, the control device further including
a variation condition storage unit (25) that stores a plurality of variation conditions for the oscillation condition calculation unit (12) to vary the amplitude information and the frequency information, wherein
the oscillation condition calculation unit (12) is capable of calculating an oscillation condition for each of the plurality of variation conditions stored by the variation condition storage unit (25).

### Additional Remark 9

The control device (1e) for the machine tool, the control device further including:
an energy calculation unit (26) that calculates acceleration/deceleration energy required for the oscillation operation on the basis of the oscillation condition; and
a display unit (27) that calculates at least either energy based on the oscillation condition set by the oscillation condition setting unit (11) or energy associated with the oscillation condition calculated by the oscillation condition calculation unit (12) and displays acceleration/deceleration energy corresponding to the oscillation condition.

### Additional Remark 10

The control device (1f) for the machine tool, the control device further including:
an energy calculation unit (31) that calculates acceleration/deceleration energy required for the oscillation operation on the basis of the oscillation condition set by the oscillation condition setting unit (11);
a standard display unit (41) that displays, as a standard, information based on the acceleration/deceleration energy calculated by the energy calculation unit (31);
a target input unit (42) that inputs target acceleration/deceleration energy determined with reference to the standard, or the proportion of decrease in the acceleration/deceleration energy with reference to the standard;
a display unit (43) that displays one or more oscillation conditions calculated such that the oscillation condition calculation unit (13) satisfies a condition input by the target input unit (42); and
a designation unit (43) that designates at least one of the oscillation conditions displayed by the display unit (43), wherein
the oscillation condition selection unit (13) selects the oscillation condition designated by the designation unit (43) or the oscillation condition (11) set by the oscillation condition setting unit (11).

### Additional Remark 11

The control device (1g) for the machine tool, the control device further including:
an oscillation condition input unit (33) that inputs an oscillation condition to serve as standard acceleration/deceleration energy associated with the oscillation operation;
an energy calculation unit (34) that calculates acceleration/deceleration energy required for the oscillation operation on the basis of the oscillation condition input by the oscillation condition input unit (33);
a target input unit (42) that inputs target acceleration/deceleration energy determined with reference to a standard constituted by information based on the acceleration/deceleration energy calculated by the energy calculation unit (34), or the proportion of decrease in the acceleration/deceleration energy with reference to the standard;
a display unit (43) that displays one or more oscillation conditions calculated such that the oscillation condition calculation unit (13) satisfies a condition input by the target input unit (42); and
a designation unit (43) that designates at least one of the oscillation conditions displayed by the display unit, wherein the oscillation condition selection unit (13) selects the oscillation condition designated by the designation unit (43) or the oscillation condition set by the oscillation condition setting unit (11).

### Additional Remark 12

The control device (1h) for the machine tool, the control device further including:
a position detection unit (45) that detects position information pertaining to a driver (30) for moving at least either the workpiece or the tool;
a position deviation calculation unit (15) that calculates a position deviation from the position information detected by the position detection unit (45); and
a learning unit (50) that calculates a correction amount for the position deviation on the basis of the oscillation command and the position deviation and corrects the position deviation by adding the calculated correction amount to the position deviation.

### EXPLANATION OF REFERENCE NUMERALS

1, 1a to 1h: Control device for machine tool
11: Oscillation condition setting unit
12: Oscillation condition calculation unit
13: Oscillation condition selection unit
14: Oscillation command calculation unit
15: First adder
16: Totalizer
17: Second adder
18: Position control unit
19: Speed/current control unit
30: Motor
45: Encoder

1. A control device for a machine tool that performs oscillation machining in which a workpiece and a tool are caused to oscillate relative to each other, the control device comprising:
an oscillation condition setting unit that sets an oscillation condition;
an oscillation condition calculation unit that calculates a different oscillation condition differing from the oscillation condition such that less acceleration/deceleration energy is required for an oscillation operation determined by the oscillation condition;
an oscillation condition selection unit that selects either of the respective oscillation conditions set by the oscillation condition setting unit and the oscillation condition calculation unit;
an oscillation command calculation unit that calculates an oscillation command on a basis of the oscillation condition selected by the oscillation condition selection unit; and
a control unit that causes the workpiece and the tool to oscillate relative to each other on a basis of a movement command convolved with the oscillation command.

2. The control device for the machine tool according to claim 1, wherein
the oscillation condition setting unit sets, as the oscillation condition, amplitude information indicating an oscillation amplitude and frequency information indicating an oscillation frequency, and
the oscillation condition calculation unit calculates, as the oscillation condition, a setting value obtained by varying the amplitude information and the frequency information.

3. The control device for the machine tool according to claim 2, the control device further comprising:
a lower-limit-value setting unit that sets a lower limit value for a setting value of at least one of the amplitude information or the frequency information, wherein
a product of the amplitude information and the frequency information calculated by the oscillation condition calculation unit is lower than a product of the amplitude information and the frequency information set by the oscillation condition setting unit, and is higher than the lower limit value.

4. The control device for the machine tool according to claim 3, the control device further comprising:
a machining condition input unit that inputs a machining condition; and
a lower-limit-value calculation unit that calculates, for the amplitude information and the frequency information, a condition required for causing an air cut on a basis of the machining condition, wherein
the lower-limit-value setting unit sets, as a lower limit value, the condition calculated for the amplitude information and the frequency information by the lower-limit-value calculation unit.

5. The control device for the machine tool according to claim 1, wherein on a basis of designation in a machining program, the oscillation condition selection unit selects either of the respective oscillation conditions set by the oscillation condition setting unit and the oscillation condition calculation unit.

6. The control device for the machine tool according to claim 1, wherein the oscillation condition selection unit selects, on a basis of a signal input from outside, either of the respective oscillation conditions set by the oscillation condition setting unit and the oscillation condition calculation unit.

7. The control device for the machine tool according to claim 1, wherein the oscillation condition selection unit selects, on a basis of at least one of a predesignated machining section or machining time, either of the respective oscillation conditions set by the oscillation condition setting unit and the oscillation condition calculation unit.

8. The control device for the machine tool according to claim 2, the control device further comprising:
a variation condition storage unit that stores a plurality of variation conditions for the oscillation condition calculation unit to vary the amplitude information and the frequency information, wherein
the oscillation condition calculation unit is capable of calculating an oscillation condition for each of the plurality of variation conditions stored by the variation condition storage unit.

9. The control device for the machine tool according to claim 1, the control device further comprising:
an energy calculation unit that calculates acceleration/deceleration energy required for the oscillation operation on a basis of the oscillation condition; and
a display unit that calculates at least either energy based on the oscillation condition set by the oscillation condition setting unit or energy associated with the oscillation condition calculated by the oscillation condition calculation unit and displays acceleration/deceleration energy corresponding to the oscillation condition.

10. The control device for the machine tool according to claim 1, the control device further comprising:
an energy calculation unit that calculates acceleration/deceleration energy required for the oscillation operation on a basis of the oscillation condition set by the oscillation condition setting unit;
a standard display unit that displays, as a standard, information based on the acceleration/deceleration energy calculated by the energy calculation unit;
a target input unit that inputs target acceleration/deceleration energy determined with reference to the standard, or a proportion of decrease in the acceleration/deceleration energy with reference to the standard;
a display unit that displays one or more oscillation conditions calculated such that the oscillation condition calculation unit satisfies a condition input by the target input unit; and
a designation unit that designates at least one of the oscillation conditions displayed by the display unit, wherein
the oscillation condition selection unit selects the oscillation condition designated by the designation unit or the oscillation condition set by the oscillation condition setting unit.

11. The control device for the machine tool according to claim 1, the control device further comprising:
an oscillation condition input unit that inputs an oscillation condition to serve as standard acceleration/deceleration energy associated with the oscillation operation;
an energy calculation unit that calculates acceleration/deceleration energy required for the oscillation operation on a basis of the oscillation condition input by the oscillation condition input unit;
a target input unit that inputs target acceleration/deceleration energy determined with reference to a standard constituted by information based on the acceleration/deceleration energy calculated by the energy calculation unit, or a proportion of decrease in the acceleration/deceleration energy with reference to the standard;
a display unit that displays one or more oscillation conditions calculated such that the oscillation condition calculation unit satisfies a condition input by the target input unit; and
a designation unit that designates at least one of the oscillation conditions displayed by the display unit, wherein
the oscillation condition selection unit selects the oscillation condition designated by the designation unit or the oscillation condition set by the oscillation condition setting unit.

12. The control device for the machine tool according to claim 1, the control device further comprising:
a position detection unit that detects position information pertaining to a driver for moving at least either the workpiece or the tool;
a position deviation calculation unit that calculates a position deviation from the position information detected by the position detection unit; and
a learning unit that calculates a correction amount for the position deviation on a basis of the oscillation command and the position deviation and corrects the position deviation by adding the calculated correction amount to the position deviation.
